(19) United States
(12) Patent Application Publication
(10) Pub. No.: US 2007/0233932 A1
(43) Pub. Date: Oct. 4, 2007

(54) Dynamic presence vector scaling in a coherency directory

(76) Inventors: Josh D. Collier, Royersford, PA (US); Joseph S. Schibinger, Phoenixville, PA (US); Craig R. Church, Wayne, PA (US)

Correspondence Address: Unisys Corporation;Attn: Richard Gregson, Unisys Way, MS/E8-114, Blue Bell, PA, 19424-0001, US

(21) Appl. No.: 11/540,273

(22) Filed: Sep. 29, 2006

Related U.S. Application Data
(60) Provisional application No. 60/722,092, filed on Sep. 30, 2005.
(60) Provisional application No. 60/722,317, filed on Sep. 30, 2005.
(60) Provisional application No. 60/722,623, filed on Sep. 30, 2005.
(60) Provisional application No. 60/722,633, filed on Sep. 30, 2005.

(51) Int. Cl. G06F 12/00

(52) U.S. Cl. 711/100

(57) ABSTRACT

In a system of multiple caching agents accessing shared cache lines, a dynamic vector scaling mechanism is achieved through the selection of a mode to grant a caching agent that requests access to a cache line. Cache line entries in a directory indicate the particular caching agents that are sharing the line of cache. Modes may include a grouping of multiple caching agents or a representation of a single caching agent. A mode may be determined for additional caching agents. The selection and determination may include determining whether to maintain or change the modes of the caching agents. The selection of the modes for the caching agents may allow the vector to assume a representation in which the caching agents are grouped in such a way as to reduce a number of invalidation requests of a cache line.

### REFERENCE TO RELATED APPLICATIONS

This application claims benefit under 35 U.S.C. § 119(e) of provisional U.S. Pat. Ser. Nos. 60/722,092, 60/722,317, 60/722,623, and 60/722,633 all filed on Sep. 30, 2005, the disclosures of which are incorporated herein by reference in their entirely.

The following commonly assigned co-pending applications have some subject matter in common with the current application:

U.S. application Ser. No.11/XXX,XXX filed Sep. 29, 2006, entitled “Providing Cache Coherency in an Extended Multiple Processor Environment”, attorney docket number TN426, which is incorporated herein by reference in its entirety;

U.S. application Ser. No. 11/XXX,XXX filed Sep. 29, 2006, entitled “Tracking Cache Coherency In An Extended Multiple Processor Environment”, attorney docket number TN428, which is incorporated herein by reference in its entirety; and

U.S. application Ser. No.11/XXX,XXX filed Sep. 29, 2006, entitled “Preemptive Eviction of Cache Lines From a Directory”, attorney docket number TN426, which is incorporated herein by reference in its entirety.

### FIELD OF THE INVENTION

The current invention relates generally to data processing systems and more particularly to dynamic presence vector scaling in a coherency directory.

### BACKGROUND OF THE INVENTION

In a system of multiple caching agents that share data, where a cache line is a fixed size of data, useable in a cache (local temporary storage), that is accessible and manageable as a unit and represents a portion of the system's data that may be accessed by one or more particular agents, a coherency directory may track and identify the presence of multiple cache lines in each of the caching agents. The caching agents are entities that access the cache lines of the system.

A full directory maintains information for every cache line of the system, while a sparse directory only tracks ownership for a limited, predetermined number of cache lines. In order to represent the agents of the system, each caching agent may be designated as a single bit of a bit-vector. This representation is typically reserved for small systems; larger systems, instead, may use a bit of a coarse-vector to represent a group of agents. In such a system, coarseness is the number of caching agents represented by each bit of the coarse-vector, or a vector where each bit represents more than one caching agent.

In the directory, the state of the data represented by the cache line may be identified as either modified, exclusive, shared, or invalid. In the modified and exclusive states, only one caching agent of the system may have access to the data. The shared state allows for any number of caching agents to concurrently access the data in a read-only manner, while the invalid data state indicates that none of the caching agents are currently accessing the data represented by the particular cache line.

Requests may need to be sent to one or more caching agents when a state change of a cache line is desired. One type of request is an invalidation request, which may be utilized when a particular caching agent desires modified or exclusive access to data. In such an instance, in order to allow the requesting agent proper access and if the data is currently in the shared state, invalidation requests are sent to the caching agents currently caching the desired data, in order to invalidate the cache line. In a system where a coarse-vector is used to represent a group of agents, the invalidation request is sent to all of the agents in the group to ensure that each of the agents accessing the data is invalidated. Some of the invalidation requests are unnecessary as not all agents in the group may be caching the data of interest. Accordingly, a mechanism for minimizing the number of invalidation requests of a cache line is desired.

### SUMMARY OF THE INVENTION

A dynamic vector scaling method is achieved through the selection of a mode to represent caching agents caching a cache line when granting another caching agent access to a cache line. A mode may be determined for additional caching agents. The selection and determination may include determining whether to maintain or change the modes of representation of the caching agents.

Modes may include a grouping of multiple caching agents or a representation of a single caching agent. The caching agents may be represented in a directory with a vector representation for cache lines of a system including the caching agents. The vector representation may be a coarse-vector, in which each bit of the vector represents a group of caching agents. The selection of the modes for the caching agents may allow the vector to assume a representation in which the caching agents are grouped in such a way as to reduce a number of invalidation requests of a cache line.

This Summary of the Invention is provided to introduce a selection of concepts in a simplified form that are further described below in the Detailed Description of Illustrative Embodiments. This Summary of the Invention is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of the invention are better understood when read in conjunction with the appended drawings. Exemplary embodiments of the invention are shown in the drawings, however it is understood that the invention is not limited to the specific methods and instrumentalities depicted therein. In the drawings:

FIG. 1a is a block diagram of a shared multiprocessor system;

FIG. 1b is a logical block diagram of a multiprocessor system according to an example embodiment of the present invention;

FIG. 1c illustrates a block diagram of a multi-processor system having two cells depicting interconnection of two System Controller (SC) and multiple Coherency Directors (CDs) according to an embodiment of the present invention.

FIG. 1d depicts aspects of the cell to cell communications according to an embodiment of the present invention.

FIG. 2 is a block diagram of an example dynamic vector scaling system according to an embodiment;

FIG. 3 is a diagram of an example directory according to an embodiment;

FIG. 4 is a block diagram of an example system with a coherency manager according to an embodiment;

FIG. 5 is a block diagram of an example coherency manager according to an embodiment;

FIG. 6 is a flow diagram of an example dynamic vector scaling method according to an embodiment; and

FIG. 7 is a flow diagram of an example dynamic vector scaling method according to an additional embodiment.

### DETAILED DESCRIPTION OF ILLUSTRATIVE EMBODIMENTS

Shared Microprocessor System

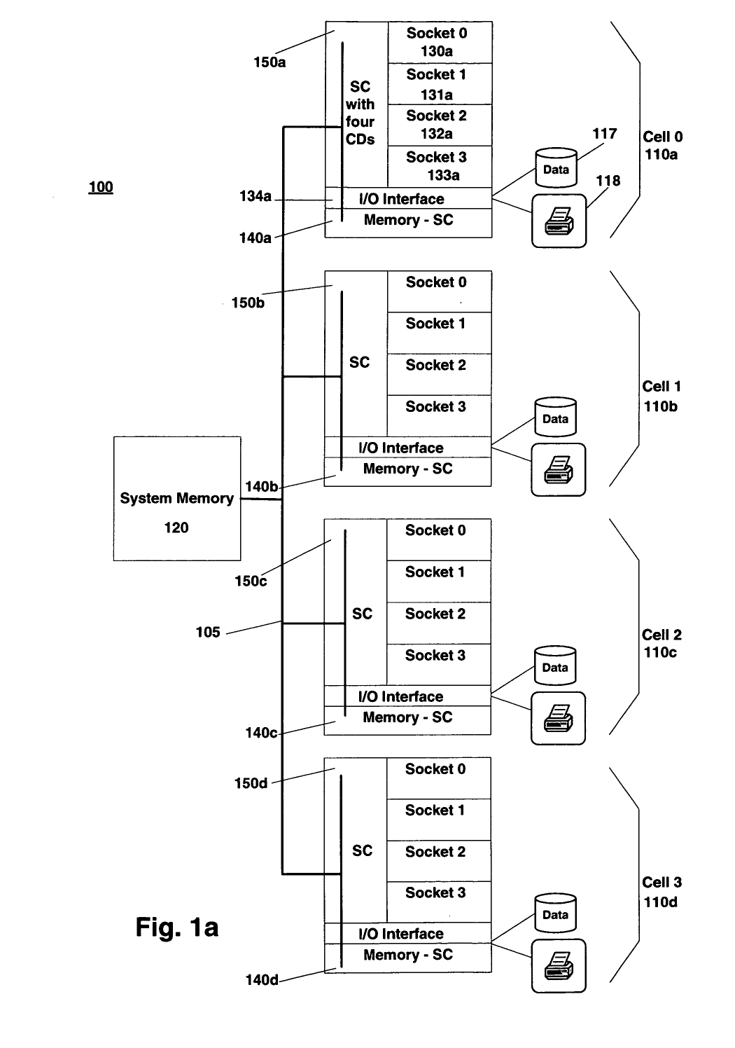

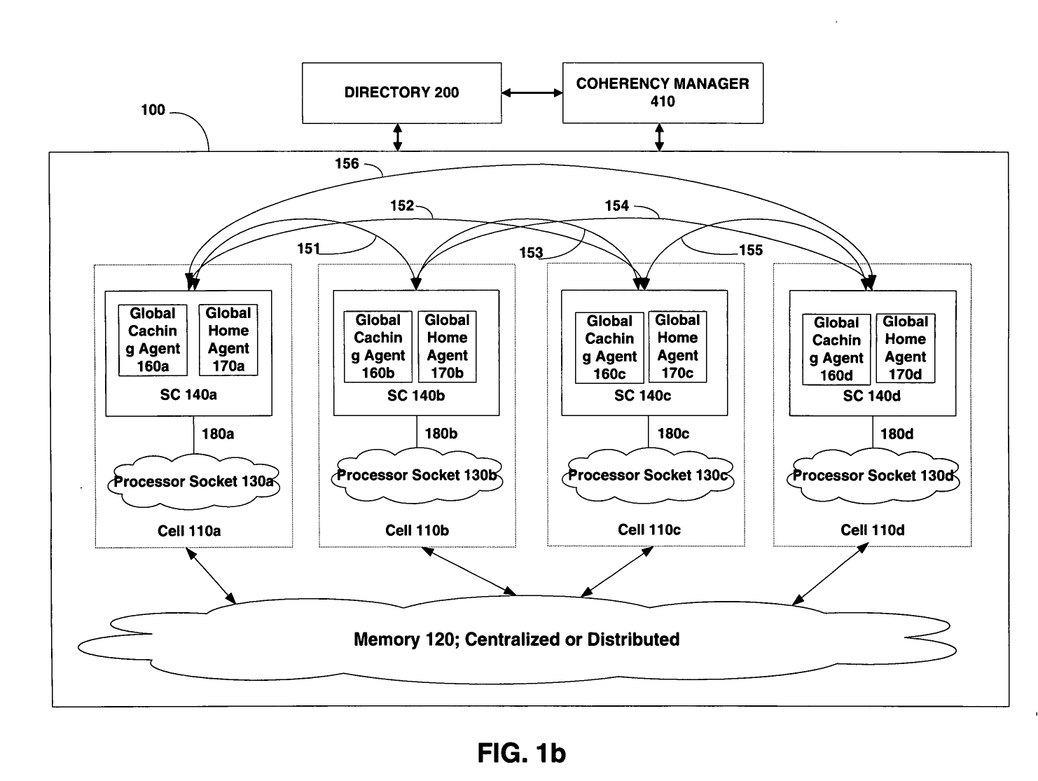

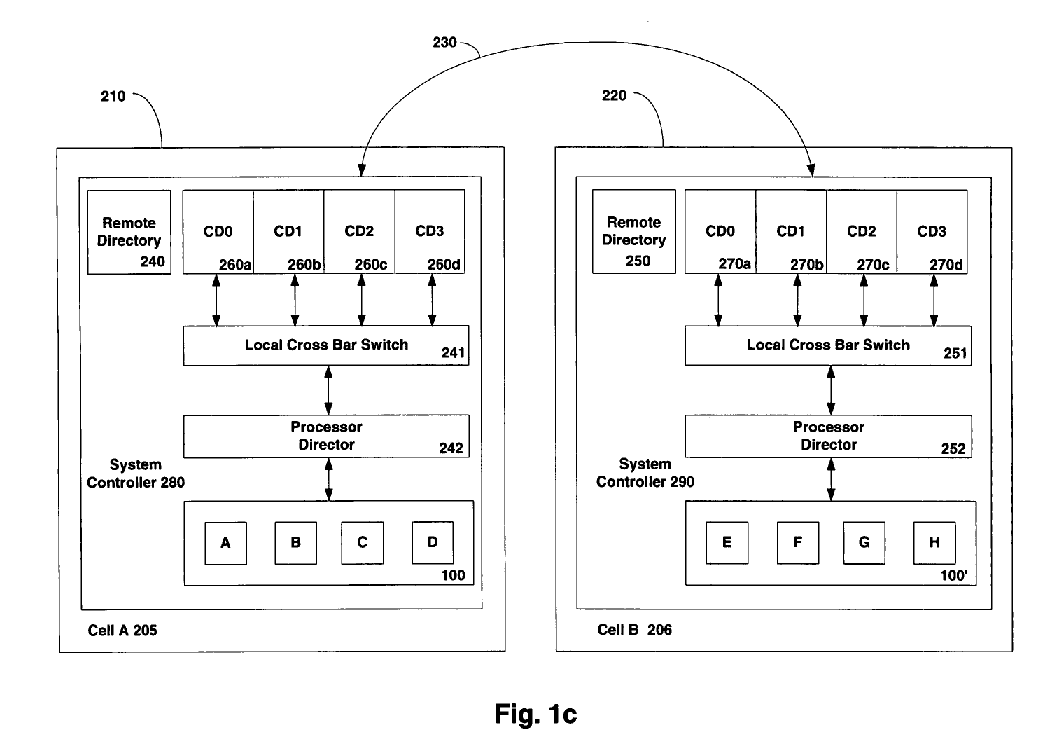

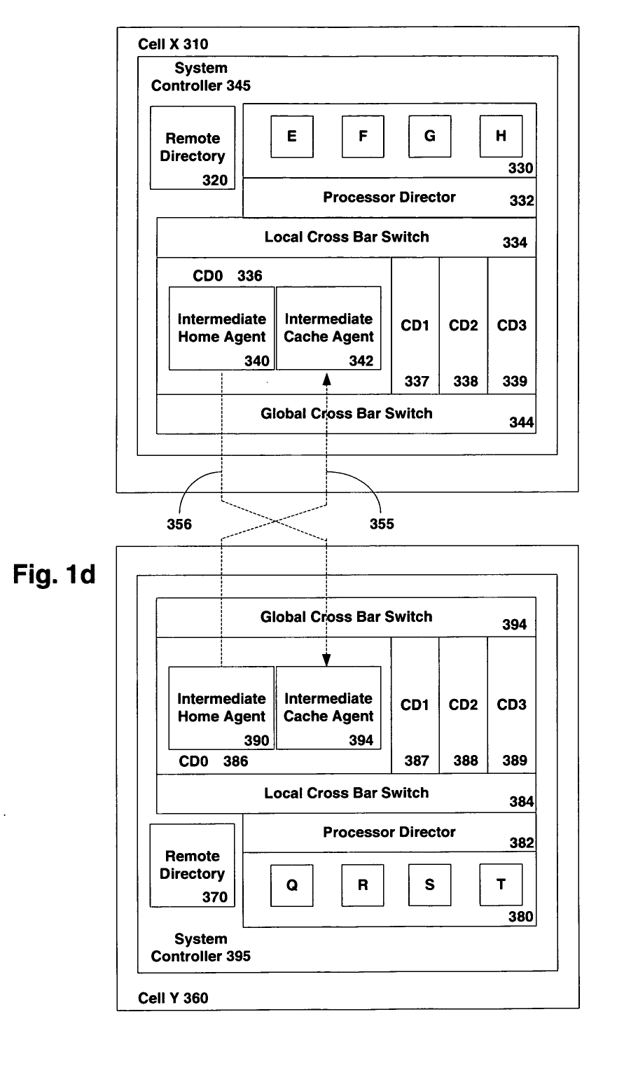

FIG. 1a is a block diagram of a shared multiprocessor system (SMP) 100. In this example, a system is constructed from a set of cells 110a-110d that are connected together via a high-speed data bus 105. Also connected to the bus 105 is a system memory module 120. In alternate embodiments (not shown), high-speed data bus 105 may also be implemented using a set of point-to-point serial connections between modules within each cell 110a-110d, a set of point-to-point serial connections between cells 110a-110d, and a set of connections between cells 110a-110d and system memory module 120.

Within each cell, a set of sockets (socket 0 through socket 3) are present along with system memory and I/O interface modules organized with a system controller. For example, cell 0 110a includes socket 0, socket 1, socket 2, and socket 3 130a-133a, I/O interface module 134a, and memory module 140a hosted within a system controller. Each cell also contains coherency directors, such as CD 150a-150d that contains intermediate home and caching agents to extend cache sharing between cells. A socket, as in FIG. 1a, is a set of one or more processors with associated cache memory modules used to perform various processing tasks. These associated cache modules may be implemented as a single level cache memory and a multi-level cache memory structure operating together with a programmable processor. Peripheral devices 117-118 are connected to I/O interface module 134a for use by any tasks executing within system 100. All of the other cells 110b-110d within system 100 are similarly configured with multiple processors, system memory and peripheral devices. While the example shown in FIG. 1a illustrates cells 0 through cells 3 110a-110d as being similar, one of ordinary skill in the art will recognize that each cell may be individually configured to provide a desired set of processing resources as needed.

Memory modules 140a-140d provide data caching memory structures using cache lines along with directory structures and control modules. A cache line used within socket 2 132a of cell 0 110a may correspond to a copy of a block of data that is stored elsewhere within the address space of the processing system. The cache line may be copied into a processor's cache memory by the memory module 140a when it is needed by a processor of socket 2 132a. The same cache line may be discarded when the processor no longer needs the data. Data caching structures may be implemented for systems that use a distributed memory organization in which the address space for the system is divided into memory blocks that are part of the memory modules 140a-140d. Data caching structures may also be implemented for systems that use a centralized memory organization in which the memory's address space corresponds to a large block of centralized memory of a system memory block 120.

The SC 150a and memory module 140a control access to and modification of data within cache lines of its sockets 130a-133a as well as the propagation of any modifications to the contents of a cache line to all other copies of that cache line within the shared multiprocessor system 100. Memory-SC module 140a uses a directory structure (not shown) to maintain information regarding the cache lines currently in used by a particular processor of its sockets. Other SCs and memory modules 140b-140d perform similar functions for their respective sockets 130b-130d.

One of ordinary skill in the art will recognize that additional components, peripheral devices, communications interconnections and similar additional functionality may also be included within shared multiprocessor system 100 without departing from the spirit and scope of the present invention as recited within the attached claims. The embodiments of the invention described herein are implemented as logical operations in a programmable computing system having connections to a distributed network such as the Internet. System 100 can thus serve as either a stand-alone computing environment or as a server-type of networked environment. The logical operations are implemented (1) as a sequence of computer implemented steps running on a computer system and (2) as interconnected machine modules running within the computing system. This implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto.

FIG. 1b is a logical block diagram of an exemplary computer system that may employ aspects of the current invention. The system 100 of FIG. 1b depicts a multiprocessor system having multiple cells 110a, 110b, 110c, and 110d each with a processor assembly or socket 130a, 130b, 130c, and 130d and a SC 140a, 140b, 140c, and 140d. All of the cells 110a-d have access to memory 120. The memory 120 may be a centralized shared memory or may be a distributed shared memory. The distributed shared memory model divides memory into portions of the memory 120, and each portion is connected directly to the processor socket 130a-d or to the SC 140a-d of each cell 110a-d. The centralized memory model utilizes the entire memory as a single block. Access to the memory 120 by the cells 110a-d depends on whether the memory is centralized or distributed. If centralized, then each SC 140a-d may have a dedicated connection to memory 120 or the connection may be shared as in a bus configuration. If distributed, each processor socket 130a-d or SC 140a-d may have a memory agent (not shown) and an associated memory block or portion.

The system 100 may communicate with a directory 200 and coherency monitor 410, and the directory 200 and the entry eviction system 300 may communicate with each other, as shown in FIG. 1b. The directory 200 may maintain information related to the cache lines of the system 100. The entry eviction system 300 may operate to create adequate space in the directory 200 for new entries. The SCs 140a-d may communicate with one another via global communication links 151-156. The global communication links are arranged such that any SC 140a-d may communicate with any other SC 140a-d over one of the global interconnection links 151-156. Each SC 140a-d may contain at least one global caching agent 160a, 160b, 160c, and 160d as well as one global home agent 170a, 170b, 170c, and 170d. For example, SC 140a contains global caching agent 160a and global home agent 170a. SCs 140b, 140c, and 140d are similarly configured. The processors 130a-d within a cell 110a-d may communicate with the SC 140a-d via local communication links 180a-d. The processors 130a-d may optionally also communicate with other processors within a cell 110a-d (not shown). In one method, the request to the SC 140a-d may be conditional on not obtaining the requested cache line locally or, using another method, the system controller (SC) may participate as a local processor peer in obtaining the requested cache line.

In system 100, caching of information useful to one or more of the processor sockets 130a-d within cells 110a-d is accommodated in a coherent fashion such that the integrity of the information stored in memory 120 is maintained. Coherency in system 100 may be defined as the management of a cache in an environment having multiple processing entities, such as cells 110a-d. Cache may be defined as local temporary storage available to a processor. Each processor, while performing its programming tasks, may request and access a line of cache. A cache line is a fixed size of data, useable by a cache, that is accessible and manageable as a unit. For example, a cache line may be some arbitrarily fixed size of bytes of memory. A cache line is the unit size upon which a cache is managed. For example, if the memory 120 is 64 MB in total size and each cache line is sized to be 64 KB, then 64 MB of memory/64 bytes cache line size=1 Meg of different cache lines.

Cache lines may have multiple states. One convention indicative of multiple cache states is called a MESI system. Here, a line of cache can be one of: modified (M), exclusive (E), shared (S), or invalid (I). Each cell 110a-d in the shared multiprocessor system 100 may have one or more cache lines in each of these different states.

An exclusive state is indicative of a condition where only one entity, such as a processor 130a-d, has a particular cache line in a read and write state. No other caching agents 160a-d may have concurrent access to this cache line. An exclusive state is indicative of a state where the caching agent 160a-d has write access to the cache line but the contents of the cache line have not been modified and are the same as memory 120. Thus, an entity, such as a processor socket 130a-d, is the only entity that has the cache line. The implication here is that if any other entity were to access the same cache line from memory 120, the line of cache from memory 120 may not have the updated data available for that particular cache line. When a socket has exclusive access, all other sockets in the system are in the invalid state for that cache line. A socket with exclusive access may modify all or part of the cache line or may silently invalidate the cache line. A socket with exclusive state will be snooped (searched and queried) when another socket attempts to gain any state other than the invalid state.

Another state of a cache line is known as the modified state. Modified indicates that the cache line is present at a socket in a modified state, and that the socket guarantees to provide the full cache line of data when snooped, or searched and queried. When a caching agent 160a-d has modified access, all other sockets in the system are in the invalid state with respect to the requested line of cache. A caching agent 160a-d with the modified state indicates the cache line has been modified and may further modify all or part of the cache line. The caching agent 160a-d may always write the whole cache line back to evict it from its cache or provide the whole cache line in a snoop, or search and query, response and, in some cases, write the cache line back to memory. A socket with the modified state will be snooped when another socket attempts to gain any state other than the invalid state. The home agent 170a-d may determine from a sparse directory that a caching agent 160a-d in a cell 110a-d has a modified state, in which case it will issue a snoop request to that cell 110a-d to gain access of the cache line. The state transitions from exclusive to modified when the cache line is modified by the caching agent 160a-d.

Another mode or state of a cache line is known as shared. As the name implies, a shared line of cache is cache information that is a read-only copy of the data. In this cache state type, multiple entities may have read this cache line out of shared memory. Additionally, if one caching agent 160a-d has the cache line shared, it is guaranteed that no other caching agent 160a-d has the cache line in a state other than shared or invalid. A caching agent 160a-d with shared state only needs to be snooped when another socket is attempting to gain exclusive access.

An invalid cache line state in the SC's directory indicates that there is no entity that has this cache line. Invalid in a caching agent's cache indicates that the cache line is not present at this entity socket. Accordingly, the cache line does not need to be snooped. In a multiprocessor environment, such as the system 100, each processor is performing separate functions and has different caching scenarios. A cache line can be invalid in any or all caches, exclusive in one cache, shared by multiple read only processes, or modified in one cache and different from what is in memory.

In system 100 of FIG. 1b, it may be assumed for simplicity that each cell 110a-d has one processor. This may not be true in some systems, but this assumption will serve to explain the basic operation. Also, it may be assumed that a cell 110a-d has within it a local store of cache where a line of cache may be stored temporarily while the processor 130a-d of the cell 110a-d is using the cache information. The local stores of cache may be a grouped local store of cache or may be a distributed local store of cache within the socket 130a-d.

If a caching agent 160a-d within a cell 110a-d seeks a cache line that is not currently resident in the local processor cache, the cell 110a-d may seek to acquire that line of cache externally. Initially, the processor request for a line of cache may be received by a home agent 170a-d. The home agent 170a-d arbitrates cache requests. If for example, there were multiple local cache stores, the home agent 170a-d would search the local stores of cache to determine if the sought line of cache is present within the socket. If the line of cache is present, the local cache store may be used. However, if the home agent 170a-d fails to find the line of cache in cache local to the cell 110a-d, then the home agent 170a-d may request the line of cache from other sources.

A number of request types and directory states are relevant. The following is an example pseudo code for an exclusive request:

```
IF the requesting agent wants to be able to write the cache
line (requests E status) THEN
  IF directory lookup = Invalid THEN
    fetch memory copy to requesting agent
  ELSE IF directory = Shared THEN
    send a snoop to each owner to invalidate their copies, wait for their
    completion responses, then fetch the memory copy to the
    requesting agent
  ELSE IF directory = Exclusive THEN
    send a snoop to the owner and depending on the response send the
    snoop response data (and optionally update memory) or memory
    data to the requesting agent
    ELSE IF directory = M THEN
    send a snoop to the owner and send the snoop response data to the
    requesting agent (and optionally update memory).
  Update the directory to E or M and the new owning caching agent.
```

The SC 140a-d that is attached to the local requesting agents receives either a snoop request or an original request. The snoop request is issued by the local level to the SC 140a-d when the local level has a home agent 170a-d for the cache line and therefore treats the SC 140a-d as a caching agent 160a-d that needs to be snooped. In this case the SC 140a-d is a slave to the local level—simply providing a snoop response to the local level. The local snoop request is processed by the caching agent 160a-d. The caching agent 160a-d performs a lookup of the cache line in the directory, sends global snoops to home agents 170a-d as required, waits for the responses to the global snoops, issues a snoop response to the local level, and updates the director.

The original request is issued by the local level to the SC 140a-d when the local level does not have a home agent 170a-d for the cache line and therefore treats the SC 140a-d as the home agent 170a-d for the cache line. The function of the home agent 170a-d is to control access to the cache line and to read memory when needed. The local original request is processed by the home agent 170a-d. The home agent 170a-d sends the request to the caching agent 160a-d of the cell 110a-d that contains the local home of the cache line. When the caching agent 160a-d receives the global original request, it issues the original request to the local home agent 170a-d and also processes the request as a snoop similar to the above snoop function. The caching agent 160a-d waits for the local response (home response) and sends it to the home agent 170a-d. The responses to the global snoop requests are sent directly to the requesting home agent 170a-d. The home agent 170a-d waits for the response to the global request (home response), and the global snoop responses (if any), and local snoop responses (if the SC 140a-d is also a local peer), and after resolving any conflicting requests, issues the responses to the local requester.

A directory may be used to track a current location and current state of one or more copies of a cache line within a processor's cache for all of the cache lines of a system 100. The directory may include cache line entries, indicating the state of a cache line and the ownership of the particular line. For example, if cell 110a has exclusive access to a cache line, this determination may be shown through the system's directory. In the case of a line of cache being shared, multiple cells 110a-d may have access to the shared line of cache, and the directory may accordingly indicate this shared ownership. The directory may be a full directory, where every cache line of the system is monitored, or a sparse directory, where only a selected, predetermined number of cache lines are monitored.

The information in the directory may include a number of bits for the state indication; such as one of invalid, shared, exclusive, or modified. The directory may also include a number of bits to identify the caching agent 160a-d that has exclusive or modified ownership, as well as additional bits to identify multiple caching agents 160a-d that have shared ownership of a cache line. For example, two bits may be used to identify the state, and 16 bits to identity up to 16 individual or multiple caching agents 160a-d (depending on the mode). Thus, each directory information may be 18 bits, in addition to a starting address of the requested cache line. Other directory structures are also possible.

FIG. 1c depicts a system where the multiprocessor component assembly 100 of FIG. 1a may be expanded to include other similar systems assemblies without the disadvantages of slow access times and single points of failure. FIG. 1c depicts two cells; cell A 205 and cell B 206. Each cell contains a system controller (SC) 280 and 290 respectively that contain the functionality in each cell. Each cell contains a multiprocessor component assembly, 100 and 100′ respectively. Within Cell A 205 and SC 280, a processor director 242 interfaces the specific control, timing, data, and protocol aspects of multiprocessor component assembly 100. Thus, by tailoring the processor director 242, any manufacturer of multiprocessor component assembly may be used to accommodate the construction of Cell A 205. Processor Director 242 is interconnected to a local cross bar switch 241. The local cross bar switch 241 is connected to four coherency directors (CD) labeled 260a-d. This configuration of processor director 242 and local cross bar switch 241 allow the four sockets A-D of multiprocessor component assembly 100 to interconnect to any of the CDs 260a-d. Cell B 206 is similarly constructed. Within Cell b 206 and SC 290, a processor director 252 interfaces the specific control, timing, data, and protocol aspects of multiprocessor component assembly 100′. Thus, by tailoring the processor director 252, any manufacturer of multiprocessor component assembly may be used to accommodate the construction of Cell A 206. Processor Director 252 is interconnected to a local cross bar switch 251. The local cross bar switch 251 is connected to four coherency directors (CD) labeled 270a-d. As described above, this configuration of processor director 252 and local cross bar switch 251 allow the four sockets E-H of multiprocessor component assembly 100′ to interconnect to any of the CDs 270a-d.

The coherency directors 260a-d and 270a-d function to expand component assembly 100 in Cell A 205 to be able to communicate with component assembly 100′ in Cell B 206. A coherency director (CD) allows the inter-system exchange of resources, such as cache memory, without the disadvantage of slower access times and single points of failure as mentioned before. A CD is responsible for the management of a lines of cache that extend beyond a cell. In a cell, the system controller, coherency director, remote directory, coherency director are preferably implemented in a combination of hardware, firmware, and software. In one embodiment, the above elements of a cell are each one or more application specific integrated circuits.

In one embodiment of a CD within a cell, when a request is made for a line of cache not within the component assembly 100, then the cache coherency director may contact all other cells and ascertain the status of the line of cache. As mentioned above, although this method is viable, it can slow down the overall system. An improvement can be to include a remote directory into a call, dedicated to the coherency director to act as a lookup for lines a cache.

FIG. 1c depicts a remote directory (RDIR) 240 in Cell a 205 connected to the coherency directors (CD) 260a-d. Cell B 206 has its own RDIR 250 for CDs 270a-d. The RDIR is a directory that tracks the ownership or state of cache lines whose homes are local to the cell A 205 but which are owned by remote nodes. Adding a RDIR to the architecture lessens the requirement to query all agents as to the ownership of non-local requested line of cache. In one embodiment, the RDIR may be a set associative memory. Ownership of local cache lines by local processors is not tracked in the directory. Instead, as indicated before communication queries (also known as snoops) between processor assembly sockets are used to maintain coherency of local cache lines in the local domain. In the event that all locally owned cache lines are local cache lines, then the directory would contain no entries. Otherwise, the directory contains the status or ownership information for all memory cache lines that are checked out of the local domain of the cell. In one embodiment, if the RDIR indicates a modified cache line state, then a snoop request must be sent to obtain the modified copy and depending on the request the current owner downgrades to exclusive, shared, or invalid state. If the RDIR indicates an exclusive state for a line of cache, then a snoop request must be sent to obtain a possibly modified copy and depending on the request the current owner downgrades to exclusive, shared, or invalid state. If the RDIR indicates a shared state for a requested line of cache, then a snoop request must be sent to invalidate the current owner(s) if the original request is for exclusive. In this case it the local caching agents may also have shared copies so a snoop is also sent to the local agents to invalidate the cache line. If an RDIR indicates that the requested line of cache is invalid, then a snoop request must be sent to local agents to obtain a modified copy if it exists locally and/or downgrade the current owner(s) as required by the request. In an alternate embodiment, the requesting agent can perform this retrieve and downgrade function locally using a broadcast snoop function.

If a line of cache is checked out to another cell, the requesting cell can inquire about its status via the interconnection between cells 230. In one embodiment, this interconnection is a high speed serial link with a specific protocol termed Unisys® Scalability Protocol (USP). This protocol allows one cell to interrogate another cell as to the status of a cache line.

FIG. 1d depicts the interconnection between two cells; X 310 and Y 380. Considering cell X 310, structural elements include a SC 345, a multiprocessor system 330, processor director 332, a local cross bar switch 334 connecting to the four CDs 336-339, a global cross bar switch 344 and remote directory 320. The global cross bar switch allows connection from any of the CDs 336-339 and agents within the CDs to connect to agents of CDs in other cells. CD 336 further includes an entity called an intermediate home agent (IHA) 340 and an intermediate cache agent (ICA) 342. Likewise, Cell Y 360 contains a SC 395, a multiprocessor system 380, processor director 382, a local cross bar switch 384 connecting to the four CDs 386-389, a global cross bar switch 394 and remote directory 370. The global cross bar switch allows connection from any of the CDs 386-389 and agents within the CDs to connect to agents of CDs in other cells. CD 386 further includes an entity called an intermediate home agent (IHA) 390 and an intermediate cache agent (ICA) 394.

The IHA 340 of Cell X 310 communicates to the ICA 394 of Cell Y 360 using path 356 via the global cross bar paths in 344 and 394. Likewise, the IHA 390 of Cell Y 360 communicates to the ICA 344 of Cell X 360 using path 355 via the global cross bar paths in 344 and 394. In cell X 310, IHA 340 acts as the intermediate home agent to multiprocessor assembly 330 when the home of the request is not in assembly 330 (i.e. the home is in a remote cell). From a global view point, the ICA of the cell that contains the home of the request is the global home and the IHA is viewed as the global requester. Therefore the IHA issues a request to the home ICA to obtain the desired cache line. The ICA has an RDIR that contains the status of the desired cache line. Depending on the status of the cache line and the type of request the ICA issues global requests to global owners (IHAs) and may issue the request to the local home. Here the ICA acts as a local caching agent that is making a request. The local home will respond to the ICA with data; the global caching agents (IHAs) issue snoop requests to their local domains. The snoop responses are collected and consolidated to a single snoop response which is then sent to the requesting IHA. The requesting agent collects all the (snoop and original) responses, consolidates them (including its local responses) and generates a response to its local requesting agent. Another function of the IHA is to receive global snoop requests, issue local snoop requests, collect local snoop responses, consolidate them, and issue a global snoop response to global requester.

The intermediate home and cache agents of the coherency director allow the scalability of the basic multiprocessor assembly 100 of FIG. 1a. Applying aspects of the current invention allows multiple instances of the multiprocessor system assembly to be interconnected and share in a cache coherency system. In FIG. 1d, intermediate home agents (IHAs) and intermediate cache agents (ICAs) act as intermediaries between cells to arbitrate the use of shared cache lines. System controllers 345 and 395 control logic and sequence events within cells x 310 and Y 380 respectively.

In one embodiment, the RDIR may be a set associative memory. Ownership of local cache lines by local processors is not tracked in the directory. Instead, as indicated before, communication queries (also known as snoop requests and original requests) between processor assembly sockets are used to maintain coherency of local cache lines in the local cell. In the event that all locally owned cache lines are local cache lines, then the directory would contain no entries. Otherwise, the directory contains the status or ownership information for all memory cache lines that are checked out of the local coherency domain (LCD) of the cell. In one embodiment, if the RDIR indicates a modified cache line state, then a snoop request must be sent to obtain the modified copy and depending on the request the current owner downgrades to exclusive, shared, or invalid state. If the RDIR indicates an exclusive state for a line of cache, then a snoop request must be sent to obtain a possibly modified copy and depending on the request the current owner downgrades to exclusive, shared, or invalid state. If the RDIR indicates a shared state for a requested line of cache, then a snoop request must be sent to invalidate the current owner(s) if the original request is for exclusive. In this case, the local caching agents may also have shared copies so a snoop is also sent to the local agents to invalidate the cache line. If an RDIR indicates that the requested line of cache is invalid, then a snoop request must be sent to local agents to obtain a modified copy if the cache line exists locally and/or downgrade the current owner(s) as required by the request. In an alternate embodiment, the requesting agent can perform this retrieve and downgrade function locally using a broadcast snoop function.

If a line of cache is checked out to another cell, the requesting cell can inquire about its status via the interconnection between the cells. In one embodiment, this interconnection is via a high speed serial virtual channel link with a specific protocol termed Unisys® Scalability Protocol (USP). This protocol defines a set of request and associated response messages that are transmitted between cells to allow one cell to interrogate another cell as to the status of a cache line.

In FIG. 1d, the IHA 340 of cell X 310 can request cache line status information of cell Y 360 by requesting the information from ICA (394) via communication link 356. Likewise, the IHA 390 of cell Y 360 can request cache line status information of cell X 310 by requesting the information from ICA 342 via communication links 355. The IHA acts as the intermediate home agent to socket 0 130a when the home of the request is not in socket 0 130a (i.e. the home is in a remote cell). From a global view point, the ICA of the cell that contains the home of the request is the global home and the IHA is viewed as the global requester. Therefore the IHA issues a request to the home ICA to obtain the desired cache line. The ICA has an RDIR that contains the status of the desired cache line. Depending on the status of the cache line and the type of request the ICA issues global requests to global owners (IHAs) and may issue the request to the local home. Here the ICA acts as a local caching agent that is making a request. The local home will respond to the ICA with data; the global caching agents (IHAs) issue snoop requests to their local cell domain. The snoop responses are collected and consolidated to a single snoop response which is then sent to the requesting IHA. The requesting agent collects all the (snoop and original) responses, consolidates them (including its local responses) and generates a response to its local requesting agent. Another function of the IHA is to receive global snoop requests, issue local snoop requests, collect local snoop responses, consolidate them, and issue a global snoop response to global requester.

The intermediate home and cache agents of the coherency director allow the upward scalability of the basic multiprocessor sockets to a system of multiple cells as in FIG. 1b or d. Applying aspects of the current invention allows multiple instances of the multiprocessor system assembly to be interconnected and share in a cache coherency system. In FIG. 1d, intermediate home agents (IHAs) and intermediate cache agents (ICAs) act as intermediaries between cells to arbitrate the use of shared cache lines. System controllers 345 and 395 control logic and sequence events within cell X 310 and cell Y 360 respectively.

Referring back to FIG. 1b, as a fixed number of bits are used to identify the caching agents accessing a cache line, the caching agents may be grouped together for identification in the directory. Thus, the caching agents 160a-d may be represented in a vector; a bit-vector is incorporated to represent each caching agent 160a-d as a single bit, and a coarse-vector is used to represent groups of caching agents 160a-d as bits of the vector. In a coarse-vector, coarseness may be defined as the number of caching agents 160a-d represented by each bit. The vector representations may be used for the shared state when multiple caching agents 160a-d are sharing the cache line. A single shared owner may be represented using a vector representation or an index notation.

For example, if the system 100 only includes six caching agents, and each of the six caching agents is accessing a particular line of cache, then the cache line representation in the directory may allow for each of the six caching agents to be represented by one bit of the six bits allotted for the identification of caching agents. However, if a larger system has 100 caching agents accessing a shared line of cache, there may not a sufficient number of bits in the directory entry to singularly represent each caching agent. Thus, some of the caching agents are grouped together and the directory entries may represent such groupings.

A dynamic vector scaling mechanism provides for the dynamic grouping of caching agents 160a-d, when the caching agents 160a-d are represented in a coarse vector, in such a way as to reduce a number of invalidation requests of a cache line. An invalidation request may be sent from a socket, such as socket 130a-d of system 100 as shown in FIG. 1b, when the socket desires modified or exclusive access of the cache line. In such an instance, in order to allow the requesting socket proper access and if the cache line is currently in the shared state, invalidation requests are sent to the sockets currently accessing the desired cache line, in order to invalidate the cache line. In a system where a coarse-vector, as opposed to a bit-vector representation, is used to represent a group of caching agents sharing the cache line, the invalidation request is sent to all of the caching agents in the group to ensure that each of the caching agents accessing the cache line in a shared state are invalidated. Some of the invalidation requests are unnecessary as not all caching agents in the group may be accessing the cache line of interest.

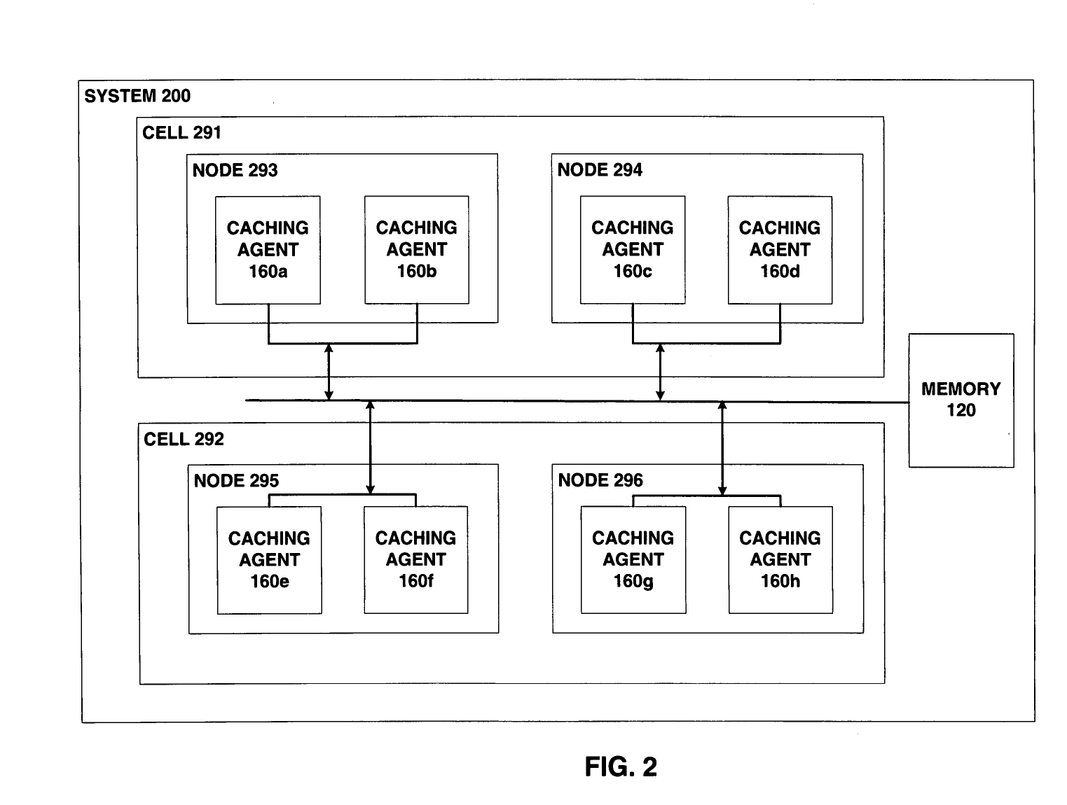

A dynamic vector scaling system may incorporate the grouping of caching agents 160a-d. An example dynamic vector scaling system 200 is illustrated in FIG. 2, in which multiple caching agents are arranged within nodes, multiple nodes are arranged within cells, and multiple cells form the system 200. As shown in FIG. 2, the system 200 has two cells (cells 291 and 292), four nodes (nodes 293, 294, 295, and 296), and eight caching agents (caching agents 160a-160h). However, the invention is not limited to a particular number of cells, nodes, and caching agents. For example, in an example embodiment (not shown), the system 200 may include sixteen cells, each cell containing four nodes, and each node containing four caching agents, resulting in a system of 256 caching agents. Furthermore, the number of caching agents may differ between nodes. Similarly, each cell of the system may include a different number of nodes.

According to an embodiment, the coarse vector has the ability to dynamically change modes in order to accommodate changes to the ownership of cache lines. The modes may be changed so that the caching agents, such as, for example, caching agents 160a, 160c, 160e, and 160g, are grouped in such a way that the number of invalidation requests of a cache line is reduced. The coarse vector identifying the caching agents may have one of three modes, for example: in mode one, a single caching agent is represented; mode two represents the node level (i.e., the identification of a single node); and mode three signifies the identification of a cell. In mode one, the coarse vector may represent a caching agent accessing the cache line in an exclusive and/or modified state. In modes two and three, the coarse vector may represent a group of caching agents sharing the cache line. For example, a coarse vector representing a cache line may include a grouping in mode two, in which the vector may represent a node, such as node 294 of the system 200. Although mode one, mode two, and mode three are described, the invention is not limited to any particular modes or any particular number of modes. For example, another mode may represent a system level, such as the system 200 as illustrated in FIG. 2.

As the number of caching agents in a group increases, the coarseness of the coarse vector increases, where coarseness may be defined as the number of caching agents represented by a single bit. For example, a coarse vector in mode three has a higher coarseness than one in mode two, which in turn has a higher coarseness than a coarse vector represented in mode one. According to an embodiment, the coarse vector may be incorporated into the entry of the cache lines in the directory 300 to indicate the caching agents, or the group of caching agents, utilizing the cache lines.

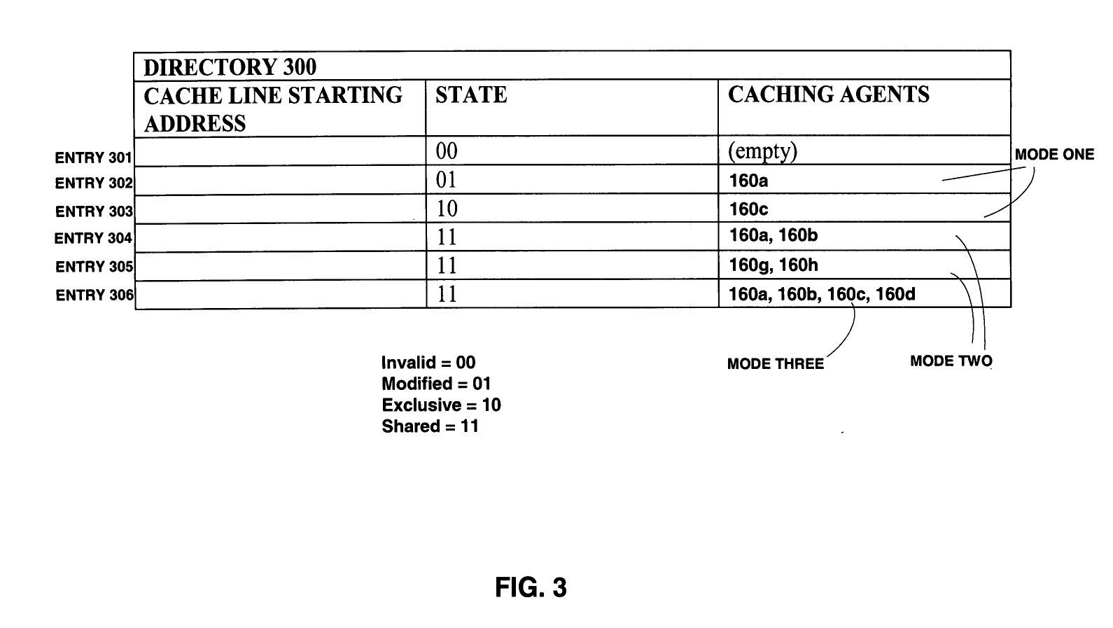

An example directory is shown in FIG. 3. The directory 300 includes example entries for six cache lines. In the example shown, each entry may include bits for the cache line. The directory 300 may be a set associative structure as explained earlier. The cache lines may be fixed sizes and aligned on 64 Byte boundaries starting 1s 6 bits of address=0 and ending at the 64^{th} Byte at 1s 6 bits of address=63, two bits for the state, and six bits to identify the caching agents accessing the particular line. The caching agents and groups of caching agents are assigned identifications for the directory entries. The invention is not limited to any particular caching agent identification scheme.

The first cache line entry 301 of the directory 300 is in an invalid state in which no caching agents are accessing this line of cache. The “00” represents the invalid state and the caching agents entry is empty since the cache line is not being used by any caching agents. The next example entry, entry 302, indicates a modified state (“01”) for the cache line, and the caching agent accessing this particular line of cache is caching agent 160a. The following entry 303 is for an exclusive state (“10”) of the cache line, which is being accessed by, for example, caching agent 160c. Programmable registers define the mapping between the vector notation and the agent ID notation. The agent ID notation is used to direct transactions and responses to their destination.

When cache lines are in the shared state (“11”), as they are in the following three example entries 304, 305, and 306 of the directory 300, groups, and thus modes, may be incorporated into the entries. For example, the fourth and fifth entries 304 and 305 indicate mode two groupings, where the node is identified. In the fourth entry 304, node 293 is identified, indicating that caching agent 160a and caching agent 160b may be accessing the fourth-identified cache line. In the fifth entry 305, node 296 is identified, indicating that caching agent 160g and caching agent 160h may be accessing this cache line. The last example entry 306 is also an entry for a shared line of cache. In this entry, another group is incorporated, this time grouping caching agents 160a, 160b, 160c, and 160d together. This group is in mode three, in which the cell may be identified. In the example shown, the cell is cell 291, which includes caching agents 160a, 160b, 160c, and 160d.

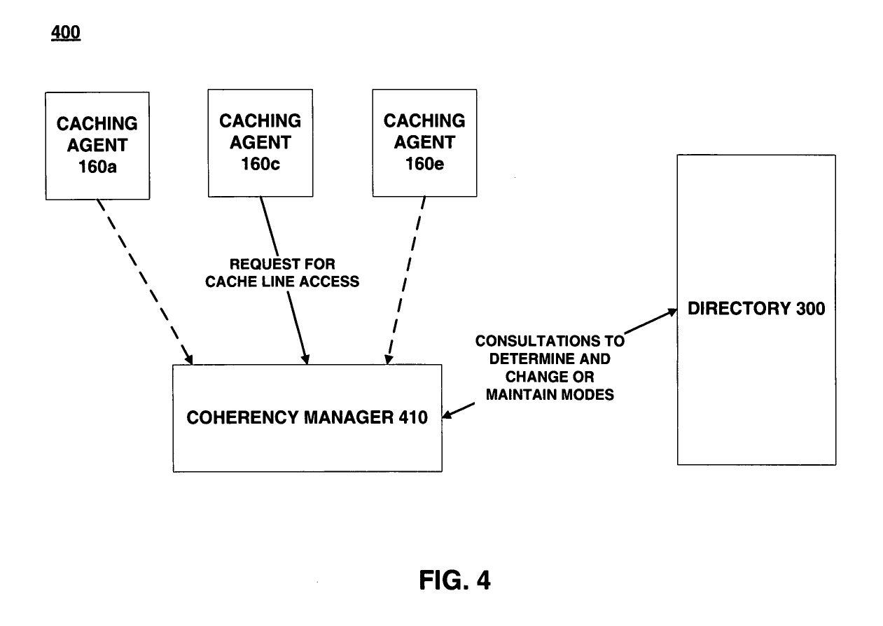

FIG. 4 illustrates an example system 400 utilizing a coherency manager 410 to dynamically change the modes of the caching agents and thus the vector identifying the caching agents in the directory. Caching agents 160a, 160c, and 160e are part of the system 400 illustrated in FIG. 4, although additional caching agents, or fewer caching agents, may form part of the system 400. A directory, such as the directory 300, is also part of the system 400. The caching agents 160a, 160c, and 160e, the coherency manager 410, and the directory 300 may be remote components residing on different computer systems or servers or may be local to a computer system or server.

A caching agent, such as caching agent 160c as shown in FIG. 4, may request access to a particular cache line. The coherency manager 410 receives and processes the caching agent's request. The caching agents 160a and 160e may also request access to a cache line, as the dotted lines from the caching agents 160a and 160e to the coherency manager 410 indicate. The processing of the request involves reference to the directory 300. If the caching agent is requesting access to, for example, a shared cache line, the coherency manager 410 may, through a consultation with the directory 300, note that the requested cache line is in a shared state. The coherency manager 410 may allow the requesting caching agent to have shared access to the cache line. If access is requested to an invalid cache line, the requesting caching agent 160c may also be granted shared access to the cache line, and the cache line's state changes from an invalid state to a shared state.

The coherency manager 410 may also select a mode to grant the requesting caching agent, in this example the caching agent 160c. The selection of the mode affects the vector that identifies the caching agents accessing a cache line, as represented in the directory 300, and is performed so that the caching agents are grouped in a way that reduces the number of invalidation requests that may be necessary when a state change is later requested. The selection of the mode may include choosing to keep the caching agent in its current mode or choosing to change the caching agent's mode.

The caching agent 160c may be in one of three dynamic modes for a shared state, and the dynamic modes may be preconfigured. Other modes, such as invalid and error may also occur. If the coherency manager 410 chooses to change the mode to mode one, then caching agent 160c would be represented, in the coarse vector identifying the cache line that caching agent 160c is now accessing, as a singular caching agent. Mode one may be referred to as S_{SKT1} mode, indicating a single caching agent accessing the cache line in a shared state.

If however, the coherency manager instead makes the determination to change the caching agent 160c to mode two, the caching agent 160c would be grouped with other caching agents so that the node, such as node 293, 294, 295, or 296, is identified in the coarse vector for the cache line. Mode two may be referred to as S_{SKTQ} mode, indicating that Q caching agents may be sharing the cache line. Q may, in an embodiment, be two, three, or four caching agents in a node.

If the caching agents exceed the capacity of S_{SKT1} and S_{SKTQ}, then mode 3 may be identified in the coarse vector. If the caching agent 160c is changed to mode three, as determined by the coherency manager 410, then the caching agent 160c would be grouped with other caching agents so that the cell, such as cell 291 or cell 292 of the system 200, is identified in the coarse vector for the cache line. The grouping may be preconfigured depending on the size of the system 200. For example, S_{SSFS} may indicate eight caching agents in two cells, while S_{PS} may indicate eight pairs of caching agents in four cells, and S_{LSCS} may indicate eight quads of caching agents in eight cells.

The coherency manager 410 may also assess the modes of other caching agents of the system 400 and determine if their modes should be changed so that the caching agents are grouped in a way that reduces the number of invalidation requests that may be necessary when a state change is later requested. For example, the coherency manager 410 may decide if the mode of the caching agent 160e should be modified. The coherency manager 410 may change the mode of the caching agent 160e to mode one (S_{SKT1}), mode two (S_{SKT2}), or mode three (S_{SSFS}/S_{PS}/S_{LCS} (S_{VEC})), as described in more detail above. Other modes are also possible.

Similar to deciding if the mode of the caching agent 160e should be changed, the coherency manager 410 may perform similar determinations with other caching agents of the system in which it is operating, such as system 400 of FIG. 4. The decision to change a mode of the caching agents results in the reduction of invalidation requests by grouping the caching agents in groups that may, for example, have a high probability of accessing the same cache line. For example, suppose an invalidation request is to be sent to the caching agents accessing a cache line and that those caching agents are grouped together in mode two, as identified in a vector which represents the cache line. Since the caching agents are grouped together, when the invalidation request is sent, the request is meaningful for all caching agents in that group. If, in contrast, the caching agents are randomly grouped, several caching agents may receive invalidation requests that do not apply to them. The size of groups may be pre-determined according to the number of cells in the system. The grouping may reflect a topology of the system 200 so caching agents located close to each other may be grouped rather than those located further apart.

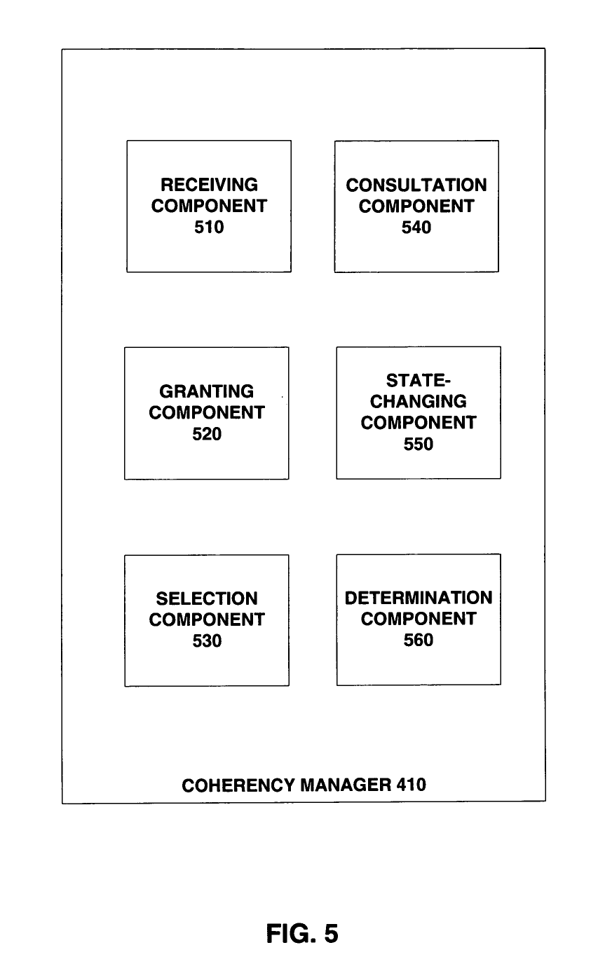

FIG. 5 illustrates a block diagram of an example coherency manager 410, which may operate to dynamically change the modes of the caching agents and thus the vector identifying the caching agents in the directory. The coherency manager 410 includes several means, devices, software, and/or hardware for performing functions, including a receiving component 510, a granting component 520, and a selection component 530.

The receiving component 510 for may operate to receive a request from a first caching agent for access to a cache line. The granting component 520 of the coherency manager 410 may grant the first caching agent access to the requested cache line. Access may be granted depending upon the state of the cache line of interest. If the desired cache line is in a shared or an invalid state, access to the cache line may be granted by the granting component 520, as discussed in further detail above.

If access to the cache line is granted by the granting component 520, the selection component 530 may select a mode to grant the first caching agent. The selection of the mode may involve choosing the mode so that the selected mode represents a smaller number of caching agents than other modes. The first caching agent's selected mode may be one of mode one, mode two, mode three, or other possible modes as discussed above. In another embodiment, the selection component 530 may perform the selection using a previously determined mode.

The coherency manager 410 may also include a consultation component 540 and a state-changing component 550, as shown in FIG. 5. The consultation component 540 may consult the directory 300 in order to determine the state of the requested cache line. If access to the requested cache line is granted, as determined by the granting component 520, it may be necessary to change the state of the cache line as indicated in the directory 300. The consultation component 540 determines if the state change is necessary, and the state-changing component 550 may perform the state change of the cache line. This state change occurs if access to the requested cache line is granted. If access is not granted, the state of the cache line may not change.

A determination component 560 may also be part of the coherency manager 410. The determination component 560 may determine whether to maintain or change a mode of a second caching agent. This determination may be based on, for example, the desirability to group caching agents in order to reduce the number of invalidation requests that may be necessary when a state change is later requested. Mode one (S_{SKT1}) may be used if sufficient, followed by mode two (S_{SKT2}), then mode three (S_{VEC}).

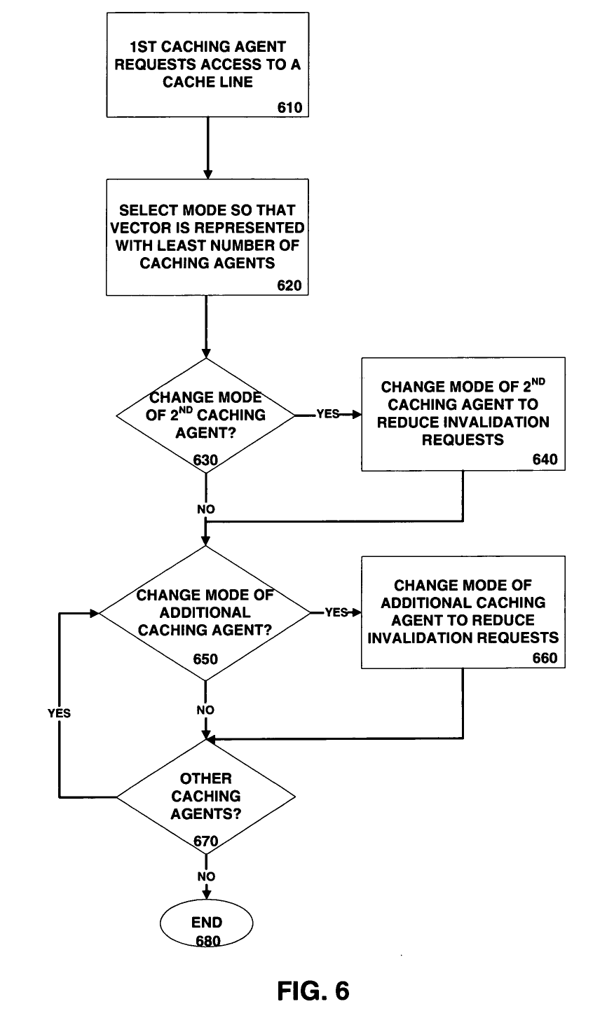

A dynamic vector scaling method is described with respect to the flow diagram of FIG. 6. At step 610, a first caching agent, such as the caching agent 160c, requests access to a cache line. At step 620, a mode to grant the first caching agent is determined.

For example, the first caching agent's mode may be one of mode one, mode two, or mode three, as described above. The determination of a mode may include choosing if the first caching agent 160c should be represented, in the vector for the requested cache line, singularly (mode one); at the node level and grouped with other caching agents of the system, such as the system 200 (mode two); or at the cell level, where the cell may be identified but the particular node and caching agent may be unknown (mode three). Both mode two and mode three represent an association of the first caching agent, in this example caching agent 160c, with at least one other caching agent of the system 100. For example and with reference to FIG. 2, in mode two, caching agent 160c may be grouped with caching agent 160d so that the node 294 is identified. Or caching agent 160c may be grouped with caching agents 160a, 160b, and 160d to allow for the identification of cell 291. Other groupings, not shown in FIG. 2, are also possible. For example, another cell may group together nodes 293 and 295.

A vector representation may be incorporated, where the association of caching agents is represented as bits of the vector. Each mode provides a different association of caching agents to each bit of the vector. The mode of the first caching agent may be selected so that the vector is represented with a least number of caching agents as possible (shown as step 620 in FIG. 6). The vector representation may be part of an entry in the directory 300, as further discussed above with respect to FIG. 3, where the directory 300 may be a full directory or a sparse directory.

The dynamic vector scaling method may also include an operation that tracks previous requests for access to a cache line and the resulting modes that are granted in response to the cache line access requests. In this embodiment, selecting the mode to grant the first caching agent may include selecting a mode that represents a smaller number of caching agents than other modes. For example, mode one may be selected, which represents a single caching agent, rather than mode two or mode three.

At step 630, a decision is made if the mode of a second caching agent, such as caching agent 160d, may be changed. This step may occur to allow for a grouping of caching agents that reduces the number of invalidation requests that may be necessary when a state change is later requested. For example, the coherency manager 410 may determine that caching agents 160c and 160d should be grouped together in mode two (the node level mode) since, for example, caching agents 160c and 160d typically occupy the same lines of cache. If it is determined that the mode of the second caching agent should be changed at step 630, then at step 640, the second caching agent is grouped in a mode to reduce the number of invalidation requests.

Similar to the mode determination made for the first caching agent, the determination of the mode may include choosing if the second caching agent should be represented singularly (mode one); at the socket level, where the second caching agent is grouped with other caching agents of the system 200 (mode two); or at the cell level, where the cell may be identified but the particular node and caching agent may be unknown (mode three).

The method proceeds to step 650, where a decision is made if the mode of an additional caching agent may be changed. Again, this step may occur to allow for a grouping of caching agents that reduces the number of invalidation requests that may be necessary when a state change is later requested. If it is determined that the mode of the additional caching agent should be changed at step 650, then at step 660, the additional caching agent is grouped in a mode to reduce the number of invalidation requests.

From step 650 or step 660, a determination is made at step 670 if additional caching agents exist in the system, such as the system 200. If there is an additional caching agent, the method proceeds back to step 650, where a decision is made to change the mode of the additional caching agent. The dynamic vector scaling method may make such a determination for all remaining caching agents of the system. When the determination has been made for all caching agents, then the method ends at step 680.

The following table describes several requests and functions for a shared cache line, exclusive cache line, and an invalidate cache line. A flush function may remove all cache lines and update memory. The modes of the directory may be the states in the state machine described in the table. The states are I=Invalid, E=Exclusive, S1=S_{SKT1}, S2=S_{SKT2}, Sv=S_{VEC}.

| Present | | | Next | |
|---|---|---|---|---|
| State | Request | Conditions | State | Comments |
| I | Exclusive | — | E | — |
| I | Shared | — | S1 | — |
| I | Invalid | — | I | — |
| I | None | — | I | — |
| S1 | Exclusive | — | E | — |
| S1 | Shared | Same NCID | S1 | Request from same cell as current shared cell |
| S1 | Shared | (Not Same NCID) AND | S2 | A new cell and this is the second caching agent to |
| | | (current entries = 1) | | get S ownership. |
| S1 | Shared | (Not Same NCID) AND | Sv | A new cell and this is the third or greater caching |
| | | (current entries > 1) | | agent to get S ownership. |
| S1 | Invalid | — | I | — |
| S1 | None | — | S1 | — |
| S2 | Exclusive | — | E | — |
| S2 | Shared | Requesting agent ID already | S2 | An agent may request a shared cache line even |
| | | in S2 | | though the directory already has a shared entry for |
| | | | | that agent. |
| S2 | Shared | Requesting agent ID not in S2 | Sv | S2 can only hold 2 agent IDs in different cells |
| S2 | Invalid | — | I | — |
| S2 | None | — | S2 | — |
| Sv | Exclusive | — | E | — |
| Sv | Shared | — | Sv | — |
| Sv | Invalid | — | I | — |
| Sv | None | — | Sv | — |
| E | Exclusive | — | E | — |
| E | Shared | (Previous owner retains | S1 | Previous agent downgraded from exclusive to |
| | | shared ownership) AND | | shared. The new request is from the same cell as |
| | | (Same NCID) | | the previous agent. |
| E | Shared | (Previous retains shared | S2 | Previous agent downgraded from exclusive to |
| | | ownership) AND (Not same | | shared. The new request is not from the same cell |
| | | NCID) | | as the previous agent. |
| E | Shared | Previous owner invalidates | S1 | — |
| | | cache line | | |
| E | Invalid | — | I | — |
| E | None | — | E | — |

The above table indicates two types of requests for a shared request: a read code request and a read data request. The read code request may result in the shared state; the read data request may result in either a shared state or an exclusive state. The coherency manager 410 may have a set of programmable options that attempt to force read data to always give shared or exclusive ownership in addition to the normal function, resulting in performance optimization. The read date request may result in a shared request or an exclusive request. Some programs may begin by reading in data as shared and then later proceeding to write to the data, requiring two transactions: read data and an exclusive request. Setting the switch to read exclusive on the read data eliminates the exclusive request. Another switch may block the multiple shared owners. Programmable options also may provide a way of measuring the benefit of multiple shared copies and the benefit of shared state.

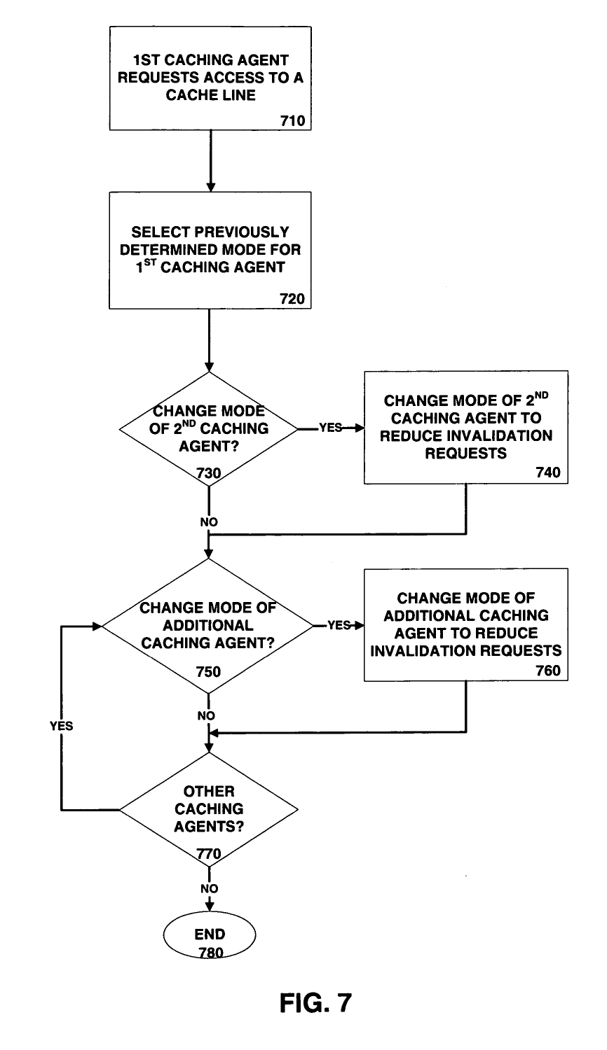

A dynamic vector scaling method according to an additional embodiment is described with respect to the flow diagram of FIG. 7. Similar to the method shown in and described with relation to FIG. 6, at step 710 a first caching agent, such as the caching agent 160c, requests access to a cache line. Next, a mode to grant the first caching agent is determined

In this embodiment, at step 720, the mode to grant the first caching agent may have been previously determined. In such an embodiment, a predetermined mode may be identified and selected based upon various system constraints and operations.

The method proceeds to step 730, where a decision is made if the mode of a second caching agent, such as caching agent 160d, may be changed. If the decision is to change the mode of the second caching agent, then at step 740, the second caching agent is grouped in a mode to reduce the number of invalidation requests. At step 750, from either step 730 or step 740, a decision of whether the mode of an additional caching agent should be changed. If the determination is that the mode should be changed, then at step 760, the additional caching agent is grouped in a mode to reduce the number of invalidation requests.

The steps of 750 and 760 may be repeated if, at step 770, it is determined that another caching agent is part of the system. If another caching agent is present, then it is decided, at step 750, if its mode should be changed. If this step results in the decision to change the caching agent's mode, then at step 760 the additional caching agent is grouped in a mode to reduce the number of invalidation requests. This loop may continue for the remaining caching agents of the system. The dynamic vector scaling process ends at step 780.

After the modes are assigned, as shown in and described with respect to FIGS. 6 and 7, the cells 110a-110d of the system 100 may operate and communicate according to their respective functionalities. They may access lines of cache, which are represented in the directory 300, for example, described above with reference to FIG. 3. When a socket, such as the cell 110a, requests, for example, exclusive access of a cache line that is currently in a shared state, the number of invalidation requests are minimal due to the determinations of the modes for the caching agents of the system 100.

As mentioned above, while exemplary embodiments of the invention have been described in connection with various computing devices, the underlying concepts may be applied to any computing device or system in which it is desirable to implement a multiprocessor cache system. Thus, the methods and systems of the present invention may be applied to a variety of applications and devices. While exemplary names and examples are chosen herein as representative of various choices, these names and examples are not intended to be limiting. One of ordinary skill in the art will appreciate that there are numerous ways of providing hardware and software implementations that achieves the same, similar or equivalent systems and methods achieved by the invention.

As is apparent from the above, all or portions of the various systems, methods, and aspects of the present invention may be embodied in hardware, software, or a combination of both. For example, the elements of a cell may be rendered in an application specific integrated circuit (ASIC) which may include a standard or custom controller running microcode as part of the included firmware.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

What is claimed:

1. A dynamic vector scaling method, comprising:
receiving a request from a first caching agent in a directory for access to a cache line;
selecting a mode to grant the first caching agent; and
determining a mode of a second caching agent in the directory.

2. The method of claim 1, wherein determining the mode of the second caching agent comprises determining whether to maintain or change the mode of the second caching agent.

3. The method of claim 1, wherein selecting the mode to grant the first caching agent comprises choosing if the first caching agent should be represented as an individual caching agent or associated with other caching agents.

4. The method of claim 1, wherein each mode comprises an individual caching agent or a group of caching agents.

5. The method of claim 1, further comprising:
representing caching agents in the directory with a vector representation.

6. The method of claim 1, further comprising:
tracking previous requests and resulting modes;
wherein selecting the mode to grant the first caching agent comprises selecting a mode that represents a smaller number of caching agents than other modes.

7. The method of claim 1, wherein selecting a mode to grant the first caching agent comprises selecting a mode for the first caching agent to reduce invalidation requests, the method further comprising:
receiving a state change request for the cache line; and
sending invalidation requests to the caching agents accessing the cache line.

8. The method of claim 1, wherein selecting the mode to grant the first caching agent comprises selecting a predetermined mode.

9. The method of claim 1, further comprising:
determining modes of additional caching agents in the directory.

10. The method of claim 9, wherein determining modes of additional caching agents in the directory comprises determining whether to maintain or change the mode of each of the additional caching agents.

11. A dynamic vector scaling system, comprising:
a first caching agent that requests access to a cache line;
a directory; and
a coherency manager that consults the directory to select a mode to grant the first caching agent.

12. The system of claim 11, further comprising a second caching agent, wherein the directory maintains a vector representation of the first and second caching agents.

13. The system of claim 11, wherein the coherency manager consults the directory to select a mode to grant a second caching agent.

14. The system of claim 11, further comprising:
a plurality of caching agents;
wherein the coherency manager consults the directory to select a mode to grant each of the plurality of caching agents.

15. The system of claim 11, wherein each mode comprises an individual caching agent or a group of caching agents.

16. The system of claim 11, wherein the cache line is in a shared state.

17. A coherency manager, comprising:
a receiving component for receiving a request from a first caching agent for access to a cache line;
a granting component for granting access to the requested cache line; and
a selection component for selecting a mode to grant the first caching agent.

18. The coherency manager of claim 17, further comprising:
a consultation component for consulting a directory; and
a state-changing component for changing the state of the cache line, based on the consultation with the directory, if access to the requested cache line is granted.

19. The coherency manager of claim 17, wherein the selection component selects the mode to grant the first caching agent, wherein the selected mode represents a smaller number of caching agents than other modes.

20. The coherency manager of claim 17, further comprising:
a determination component for determining whether to maintain or change a mode of a second caching agent.
